(19) United States
(12) Patent Application Publication
(10) Pub. No.: US 2015/0289031 A1
(43) Pub. Date: Oct. 8, 2015

(54) AMERICA'S LOCAL SCENE

(71) Applicant: Louis J. Scorpiniti, Des Moines, IA (US)

(72) Inventor: Louis J. Scorpiniti, Des Moines, IA (US)

(21) Appl. No.: 14/678,365

(22) Filed: Apr. 3, 2015

Related U.S. Application Data
(60) Provisional application No. 61/974,618, filed on Apr. 3, 2014.

(51) Int. Cl. H04N 21/81; A63F 9/00; H04N 21/45; A63F 13/00; H04N 21/478; H04N 21/435

(52) U.S. Cl. CPC H04N 21/8126; H04N 21/478; H04N 21/435; H04N 21/4524; A63F 13/00; A63F 9/00

(57) ABSTRACT

A method of making a television program comprising the steps of providing a television show that broadcasts ten episodes of locally submitted music videos. The method further requiring the step of selecting a winner at the end of each episode by viewers within the state, broadcasting a state championship episode that includes the winners within each state, and selecting a winner at the end of each state championship episode by viewers. The method also requires dividing the state winners into ten regions, broadcasting a regional semifinal episode, and selecting a winner at the end of each regional semifinal episode by viewers. Next, the method requires the step of broadcasting a championship episode that includes the winners of the ten regional semifinal episodes, selecting the top three winners of the championship by viewers, and broadcasting a grand championship episode where the top three winners are announced.

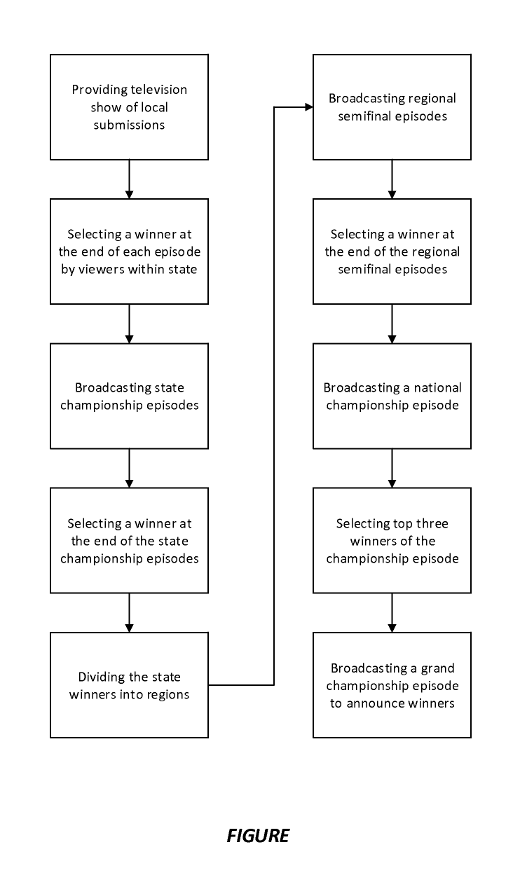

### CROSS REFERENCE TO RELATED APPLICATION

This application claims the benefit of U.S. Provisional Application No. 61/974,618 filed Apr. 3, 2014.

### BACKGROUND OF THE INVENTION

This invention is directed toward a television program, and more particularly to a television program promoting local music talent based on submitted music videos of performances.

America's Local Scene (ALS) will start out as a thirty-minute, weekly television program and it will feature America's most popular music genres. This new, prime time programming targets the 18-34 markets and will also dip into the 35-49+ and 12-17 markets as well. The program's original format gives local area performers the opportunity to send in their music video (MV) on DVD to their local ABC affiliate, the network used as the example network, with a “live” performance of a cover song or their own original song and if they are chosen their MV will be shown along with nine to twenty-seven other MVs during one, weekly, thirty-minute ALS program. Any original song that is submitted must be copyrighted and all MVs will have a maximum duration of two minutes (minimum duration TBA). Unlike Fox's American Idol, NBC's The Voice and CBS' In The Spotlight, ALS performers include: individuals as well as groups, i.e., singers and/or musicians in any configuration. Acoustic, electric, synthesized, orchestral, instrumental, mash-up, multi-voice harmony, solo, accompanied or a cappella, the only musical requirements are: one song, presented with entertaining and creative originality, non-profane lyrics or gestures, performed “live” and recorded on DVD without any cuts or editing whatsoever. Due to the advancements in video recording technology, now available to consumers, the time for this exact type of programming has finally arrived. ALS will directly compete with Idol, Voice and Spotlight with a completely original, universally entertaining and totally localized format. Grass-roots appeal, which is considered to be one of the most successful hooks in American television programming, is truly at the heart of America's Local Scene.

ALS' performers do not have the weekly, national, prime time, “live performance pressure” of Idol, Voice and Spotlight. Also, ALS' venue presents average, everyday Americans in the environment that they choose, unlike Idol's, Voice's and Spotlight's hand-picked individuals that all seem to fit-the-mold. Idol, Voice and Spotlight contestants only get one shot, and “live” with earth-moving pressure, as opposed to ALS' performers that get to do as many “takes” as they want in their own “no pressure” environment and they also get to choose the “take” that they want to present to the ALS viewers. ALS will be the only, music-based program where truly anyone can become a star. ALS will offer its performers “A Real Chance At Stardom” by awarding a record deal with a top, national record label as The Grand Prize, presented to The ALS National Grand Champion by a (sponsor) record label executive (or proxy) during the season-ending America's Local Scene National Grand Champion Special.

ALS' progressive “bracket competition” and localized format are just two of several factors contributing to its universal audience appeal, outstanding entertainment delivery and substantial revenue potential.

### SUMMARY OF THE INVENTION

A method of making a television program comprising the steps of providing a television show that broadcasts ten episodes of locally submitted music videos. The method further requiring the step of selecting a winner at the end of each episode by viewers within the state, broadcasting a state championship episode that includes the winners within each state, and selecting a winner at the end of each state championship episode by viewers. The method also requires dividing the state winners into ten regions, broadcasting a regional semifinal episode, and selecting a winner at the end of each regional semifinal episode by viewers. Next, the method requires the step of broadcasting a championship episode that includes the winners of the ten regional semifinal episodes, selecting the top three winners of the championship by viewers, and broadcasting a grand championship episode where the top three winners are announced.

### BRIEF DESCRIPTION OF THE DRAWINGS

The FIGURE is a schematic of the America's Local Scene television program.

### DETAILED DESCRIPTION

### The ALS State-Level Competition(s)

America's Local Scene (ALS) will start out as a thirty-minute, weekly television program and it will feature America's most popular music genres. This new, prime time programming targets the 18-34 markets and will also dip into the 35-49+ and 12-17 markets as well. The program's original format gives local area performers the opportunity to send in their music video (MV) on DVD to their local ABC affiliate with a “live” performance of a cover song or their own original song and if they are chosen their MV will be shown along with nine to twenty-seven other MVs during one, weekly, thirty-minute ALS program. Any original song that is submitted must be copyrighted and all MVs will have a maximum duration of two minutes (minimum duration TBA). Unlike Fox's American Idol, NBC's The Voice and CBS' In The Spotlight, ALS performers include: individuals as well as groups, i.e., singers and/or musicians in any configuration. Acoustic, electric, synthesized, orchestral, instrumental, mash-up, multi-voice harmony, solo, accompanied or a cappella, the only musical requirements are: one song, presented with entertaining and creative originality, non-profane lyrics or gestures, performed “live” and recorded on DVD without any cuts or editing whatsoever. Due to the advancements in video recording technology, now available to consumers, the time for this exact type of programming has finally arrived. ALS will directly compete with Idol, Voice and Spotlight with a completely original, universally entertaining and totally localized format. Grass-roots appeal, which is considered to be one of the most successful hooks in American television programming, is truly at the heart of America's Local Scene. Over ten-weeks, one ABC “master affiliate” per state, (e.g., WOI-Des Moines, for all of Iowa), will produce and broadcast ten, individual, weekly, thirty-minute ALS State Competition programs and make those programs available to their state's ABC sister affiliates for broadcast. The limited creative, technical and logistical requirements for producing each weekly program, for the fifty, local “master affiliates” consists of: choosing nine to twenty-seven, sent-in MVs, equaling approximately eighteen minutes of the program. The technical requirements to make the MVs broadcast ready are minimal Post and consists of: final broadcast output Spec'ing, Chron'ing and CC'ing (i.e.,“Tech'd”). In addition, there will be one, thirty-second program opening segment, one, thirty-second program closing segment and one, thirty-second “Here's How It All Works” segment that will be used for the entire ten-weeks. All three segments will be produced by Louis J. Scorpiniti (LJS) & the Designated Production Entity (To Be Announced-“TBA”) and provided to the fifty, ABC “master affiliates.” The “master affiliates”' remaining Post and only, weekly Camera/Production requirements to “localize” and complete each program consists of: approximately two & one-half minutes of Host (VJ) segues (using one to three local “personalities”) and includes the program intro, exit and MV segues (that are used before and/or after some of the MVs). These segments also need to be Tech'd by the “master affiliates.” Detailed preproduction, production, post-production, marketing and distribution, etc., scripts/parameters/Templates, etc., will be provided to the fifty, individual, ABC “master affiliates” by US & the Designated Production Entity (TBA). Totaling twenty-two minutes and leaving eight minutes for Commercials.

There is one Winner per week in each of the fifty, separate US states. Winners are determined in twenty-four hours by viewer voting online at each of the fifty, ABC “master affiliates”' websites as well as by toll calls. Each week's Winner is revealed at the beginning of the next week's program during a short “recap” in each of the respective, fifty US states, individually and statewide, by each of the fifty, ABC “master affiliates.”

After the ten-week “Regular Season” and the ten State Finalists are determined (i.e., the individual Winners of each weekly program, in each of the fifty, individual US states), the fifty,

ABC “master affiliates” will then each, individually produce and broadcast a one-hour Special that would also be made available to their state's ABC sister affiliates. The limited requirements for producing the ALS State Final Special consists of: the ten, individual State Winners' (already Tech'd) MVs, equaling approximately twenty minutes of the program, and the two, original, thirty-second (provided) program opening and closing segments, which require simple CG & VO modifications in Post, performed by the “master affiliates” to include: “State Final Special.” In addition, one, new, one-minute “Here's How We Got To This Point” segment will be produced by US & the Designated Production Entity (TBA), and provided to the fifty, individual “master affiliates.” The remaining Post and only Camera/Production requirements for the “master affiliates” consists of: ten, one minute interviews with each of the individual, “Regular Season” Winners (via Skype), also one, new, forty-five second program intro, and one, new, forty-five second program exit and approximately ten & one-half minutes of VJ segues (and these new segments will need to be Tech'd). Again, detailed scripts/production parameters/Templates, etc., will be provided by US & the Designated Production Entity (TBA), to the fifty ABC “master affiliates.” Totaling forty-four minutes and leaving sixteen minutes for Commercials. The Winners of the fifty, individual State Final Competitions, determined by viewer voting online and toll calls, will be revealed the next week at the beginning of the ten, Regional Semifinal Specials, in their respective regions. The Prize for Winning an individual State Final Competition is a two-hour “shoot” at their ABC “master affiliate's” studio or a remote location (whichever is best/easiest for the fifty, individual “master affiliates”). The Winner (group or individual) will be allowed exactly two hours to perform their song multiple times. After the session, The Winner will be allowed to (only) view their performances and pick the one that they will enter their Regional Semifinal with. The new MV will need to be Tech'd by the “master affiliate” before being used at the Regional Semifinal. Thereafter, the ten, individual, Regional Semifinal Specials, the National Championship Final Special & the National Grand Champion Special will all present Network Broadcast Quality (“NBQ”) MVs to the America's Local Scene viewers.

### The ALS Regional Semifinal Special(s)

One ABC “master affiliate,” in each of ten, separate US/ABC regions, will produce and broadcast the thirty minute ALS Regional Semifinal Special that will be made available for broadcast to the applicable ABC sister affiliates in their respective region. The fifty, individual, State Finals' Winners will be split-up into ten, separate regions, which will have five, individual State Final Winners in each region, e.g., WOI-Des Moines, would produce and make available for broadcast; the North Central States' Regional Semifinal Special for Iowa, Minnesota, North Dakota, South Dakota and Nebraska. The limited requirements for producing the Regional Semifinal Special for each of the ten, individual ABC “master affiliates” consists of: the five, different State Final Winners' new, NBQ MVs, equaling approximately ten minutes of the program (these NBQ MVs are already Tech'd from Winning their State Final Competitions), the two, original, thirty-second, (provided) program opening & closing segments, which require CG & VO mods in Post to include: “Regional Semifinal Special,” five, one minute segments with each of the five, different State Winners (using clips from their original MVs and their Skype interviews from their State Final Competitions, achieved in Post). Also, one new, one-minute “Here's How We Got To This Point” segment will be produced by LJS & the Designated Production Entity (TBA), and provided to the ten, individual “master affiliates.” The remaining Post and only Camera/Production requirements for the ten, regional ABC “master affiliates” consists of: approximately five minutes of VJ segues including: one, new, forty-five second program intro and one, new, forty-five second program exit (which will need to be Tech'd). Again, detailed scripts/production parameters/ Templates, etc., will be provided by LJS & the Designated Production Entity (TBA), to the ten, ABC “master affiliates.” Totaling twenty-two minutes and leaving eight minutes for Commercials.

The ten Winners of the ten, different ALS Regional Semifinal Competitions/Specials will be determined by viewer voting online and toll calls and they will be revealed at the beginning of the next week's ALS National Championship Final Special. Advancement to The ALS National Championship Final, with a “1 in 10—True Chance At Stardom,” will be The Prize for the ten, Regional Semifinals' Winners.

### The National Championship Final Special (NCF) & The National Grand Champion Special (NGC)

LJS & the Designated Production Entity (TBA), will produce and ABC will nationally broadcast the one-hour NCF Special as well as the thirty-minute NGC Special.

The ALS National Championship Final Special (NCF) will be one hour. The limited requirements for producing the NCF Special consists of: the ten, Regional Winners' new, NBQ MVs, equaling approximately twenty minutes of the program (and the MVs are already Tech'd), the two, original, thirty-second (provided) program opening and closing segments, which require CG & VO modifications in Post to include: “National Championship Final Special,” and the ten, one minute segments of each of the ten, different Regional Semifinal Winners, which shows clips from their original MVs and their Skype interviews from their State Final Competitions (already completed for the Regional Semifinals). The remaining Post and only Camera/Production requirements for this one-hour National Championship Final Special consists of: one, new, one minute “Here's How We Got To This Point” segment & approximately twelve minutes of VJ segues (& these new segments need to be Tech'd). Totaling forty-four minutes and leaving sixteen minutes for Commercials.

Twenty-four hours after the one-hour ALS NCF Special we would know who Won and also who Placed in each of the lesser positions, determined in twenty-four hours by viewer voting online and toll calls. The order in which the ten, NC Finalists have placed will determine the three NGC Finalists that will be featured on the upcoming, thirty-minute, NGC Special and their 1st, 2nd and 3rd place final positions. The three, NGC Finalists are revealed at the beginning of the next week's, thirty-minute, National Grand Champion Special.

The ALS National Grand Champion Special (NGC) will be thirty-minutes and will feature the NCF Special's; 1st, 2nd and 3rd Place Winners (previously determined by viewer voting online and toll calls). The limited requirements for producing the NGC Special consists of: the three NGC Finalists' new, NBQ MVs, equaling approximately six minutes of the program (and the MVs are already Tech'd). Also, the two, original, thirty-second (provided) program opening and closing segments, which will require CG & VO modifications in Post to include: “National Grand Champion Special” and three, thirty-second clips from the NGC Finalists' original MVs (achieved in Post). The remaining Post and only Camera/Production requirements for this NGC Special consists of: one, new, one-minute “Here's How We Got To This Point” segment and approximately twelve & one-half minutes of VJ segues including: one, new program intro and exit, one, one-minute “Next Season Starts In Weeks, So Send In Your MVs Now” segment and a three & one-half minutes (seven, thirty-second clips) “look-back segment” with the seven, losing National Championship Finalists, and possibly a live performance by The NGC Winner, and/or a jam with the NGC Winner/celebrities/two losing Finalists, etc., along with celebrities' cameos and various other VJ segues (these new segments will need to be Tech'd). Totaling twenty-two minutes and leaving eight minutes for Commercials.

The actual day of the NGC Special, the 1st, 2nd and 3rd Place Winners of the NCF Special will be brought to a Designated Production Location (TBA) for a “live” shoot with a studio audience that will include: their introductions, the introduction of The ALS National Grand Champion, The Grand Prize record deal award presentation and a “How Does It Feel To Be The First ALS National Grand Champion” final interview. Near the end of The NGC Special, the final order in which the three, present NGC Finalists places will be revealed to them and the studio audience, in reverse order, with the 1st Place ALS National Grand Champion accepting their well-earned accolades. As with all of the ALS programs/variables, etc., from the individual State Competitions down to the National Grand Champion Special and for everything in between: Pre- Production Meetings will be the proper arena to decide upon what exact procedures will be in-place to assure confidentiality for the ALS National Grand Champion Special and all other ALS programming.

As previously detailed, the limited production, post, creative, technical and logistical requirements of ALS programs makes producing each of the ten, “Regular Season,” weekly programs relatively fast and simple for the fifty, individual, ABC “master affiliates.” Here is the weekly procedure in its most basic form: there are the two, thirty-second program opening and closing segments and one, thirty-second “Here's How It All Works” (“provided”) segments that will be used for the entire, ten-week, individual State Competitions and all three will be produced by LJS & the Designated Production Entity (TBA), and provided to the fifty, individual state, “master affiliates.” The only, weekly Camera/Production/Post requirements will be: producing approximately two & one-half minutes of simple VJ segues which includes: the program's intro, exit, and MV segues (used before and/or after some of the MVs). All that remains is to view, choose and “Tech” nine to twenty-seven, sent-in MVs and then assemble the segments in Post. Again, detailed preproduction, production, post-production scripts/production parameters/Templates (including but not limited to: distribution, marketing, administrative, etc.,) will be provided by LJS & the Designated Production Entity (TBA), to the fifty, individual, ABC “master affiliates.”

Over the past few years my research and contact with ABC affiliates (as well as CBS, NBC, Fox, The CW, PBS, Cable and Independent platforms) has given me a complete and confident understanding that virtually every targeted broadcast platform can and will want to use their resources (as local commercials, platform IDs. program to program segues, and for some, special reports, talk shows and news, weather & sports producers) for something new, unique and viable with creativity, real entertainment and (highly prized) local recognition value and last-but-not-least: serious earning potential.

There will always be a considerable surplus of MVs to choose from for America's Local Scene. For example, in Iowa alone there are hundreds of professional and semi-professional individuals and groups that perform publicly across the state/region/nation that are, rightfully, proud of their performance skills, and for some, original songs as well. Then there are the several hundreds of amateur, solo artists and “garage bands” across the state that believe that they truly have-what-it-takes: good performance skills, and again for some, good, original material (or access to it), but haven't gotten their “break” yet. Now add the hundreds of Iowa high schools', colleges' and universities' music, audio/visual and even literary departments (for aspiring lyricists, poets and songwriters) and also their tens-of-thousands of students and don't forget all of Iowa's great Karaoke singers, and last but not least, the majority of performers that didn't win their ALS State Competition the first time they entered, that will go-back-to-the-drawing-board, come up with a better MV and enter again next season (or possibly later in the current season-TBA). Furthermore, many of the thousands of potential Iowa performers described above have more than one song. Simply put: get access to an HD, digital camcorder (used: as inexpensive as $59-$149 at a pawn shop, and borrowed ones are free), do several takes, put the best one on DVD and send it along with your contact info to your local ABC affiliate. While watching America's Local Scene, viewers will see everything from a young amateur performing a song a cappella or accompanied by a ukulele, that was recorded on a borrowed camcorder, that will bring-down-the-house, to MVs from highly paid national club circuit performers (with virtually unlimited budgets) and was shot at The Hollywood Bowl. As long as it's performers without a record deal that are willing to follow the rules & take-their-best-shot, with ALS literally everyone has A Real Chance At Stardom.

Individual states' “favorite daughters and sons” (i.e., luminaries from several, different walks-of-life, etc.) will have the opportunity to make cameo appearances during VJ segues, program open/close, etc., to cheer-on their home state's ALS performers. In Iowa, e.g., Medal of Honor recipient & well-known music lover: Staff Sgt. Salvatore Giunta starting off the Iowa State Finals Special or Ashton Kutcher opening a regular season episode or Lobo Jones introducing a female VJ or performer and ALS Iowa will have stars like Corey Taylor, leader of Slipknot & Stone Sour, along with a few of his “famous friends,” do a song and some crazy antics, etc. This could be accomplished in several ways, e.g., during the “Regular Season” and the Regional Semifinals: at the ABC “master affiliates”' studios, and for the National Championship Final and National Grand Champion Specials: at the Designated Production Location (TBA). These cameos could also be captured in-person, via remote/studio feed, pre-recorded, Skype, etc.

My intent is to always have a mutually beneficial relationship, in all aspects, between all parties. I believe that the optimum configuration to achieve this would be: “ALS Is An ABC Original Program” and for me to co-produce ALS with ABC, using ABC's facilities (or designated outsourced entities) as well as certain ABC (or outsourced) personnel for the pre-production, production, post-production, promotional, distribution and administrative requirements. In addition to co-producer I am available (as the primary or as the co-operative) in the fields of: Project Administration, Writing, Directing and/or Supervising Editor. This configuration would produce: the National Championship Final Special and the National Grand Champion Special as well as all pre-production, production, post-production, marketing and distribution scripts/parameters/Templates, etc., (Videos and Print) concerning ALS Production, Promotion, Distribution and Administrative parameters for the fifty ABC “master affiliates” concerning their ten “Regular Season,” individual State Competition programs and State Final Special, and in addition, for ten of the “master affiliates,” Templates for their region's Regional Semifinal Special as well. Also, the one, thirty-second program opening segment, the one, thirty-second program closing segment and the one, thirty-second “Here's How It All Works” (“provided”) segments that will be used for the entire ten-weeks' “Regular Season.” Also, the one, new, one-minute “Here's How We Got To This Point” segment for the fifty, individual State Final Specials and the new “Here's How We Got To This Point” segment for the ten, Regional Semifinal Specials.

Two additional versions of America's Local Scene: the basic form of simply sending in your DVD and if your song meets the criteria it will be seen on America's Local Scene, and the version where ten different camera crews are sent out to a major city, in the ten different U.S. regions, and a bracket competition, conducted at a local, live music nightclub, narrows the competition/performers down to a smaller number of performers and then the national studio competition starts. All broadcasts will be at the national level.

In operation, a television show is provided where a performer or performers submit a video of a musical performance to television program producers based on the local state the performers are from. Videos are selected for ten separate episodes per state to be broadcast along with a short intro and exit portion, as well as a short explanation of how the television program works. At the end of each episode viewers vote for their favorite performance. At the beginning of the next episode the previous episode's winner is announced.

The winners of each of the ten episodes, within each state, are then pooled together for a state championship episode. The winner of each separate state championship is determined by the votes of viewers within each respective state, for a total of fifty state champions—one for each state.

The fifty winners of the state championships are then divided into ten regional competitions, with five winners included in each region. A new episode is broadcast with new performances from the winners that are subsequently voted on by the viewers in each respective region for a total of ten regional winners that advance to the championship.

The championship episode broadcasts a live performance from the ten remaining performers. Viewers across the country vote for their favorite performance and the top three are advanced to a final grand championship round. During the grand championship episode the top three performers do a final live performance and the placement of the top three performances are announced, with the winner of the championship episode being announced last.

What is claimed is:

1. A method of making an America's Local Scene television program comprising the steps of:
providing a television show that broadcasts ten episodes of locally submitted music videos related to each state;
selecting a winner at the end of each episode by viewers within the each state;
broadcasting a state championship episode that includes the winners of the ten episodes within each state;
selecting a winner at the end of each state championship episode by viewers within each state;
dividing the winners of each state championship episode into regions;
broadcasting a regional semifinal episode within each region;
selecting a winner at the end of each regional semifinal episode by viewers within each region;
broadcasting a championship episode that includes the winners of the ten regional semifinal episodes;
selecting the top three winners of the championship by viewers;
broadcasting a grand championship episode where the top three winners are announced.
